(19) United States
(12) Patent Application Publication
(10) Pub. No.: US 2004/0084261 A1
(43) Pub. Date: May 6, 2004

(54) Brake rotor with a surface having a plurality of indentations formed therein

(75) Inventors: Donald Burgoon, Gastonia, NC (US); Wenqi Qian, Fort Mill, SC (US)

Correspondence Address: PILLSBURY WINTHROP, LLP, P.O. BOX 10500, MCLEAN, VA, 22102, US

(73) Assignee: Performance Friction Corporation, Clover, SC

(21) Appl. No.: 10/337,974

(22) Filed: Jan. 8, 2003

Related U.S. Application Data
(60) Provisional application No. 60/422,855, filed on Nov. 1, 2002.

(51) Int. Cl. B60T 1/06

(52) U.S. Cl. 188/218 XL; 188/17; 188/18 A; 188/264 A

(57) ABSTRACT

A rotor for use in an automobile braking assembly has a plurality of indentations or dimples formed on the brake pad contact surface of the rotor. The dimples may be arranged in a pattern on the surface. The pattern can be a series of aligned dimples that extend radially in groups around the circumference of the disk. The disk may be ventilated. The dimpled rotor provides enhanced friction, without increased noise, and promotes uniform temperature distribution.

### BACKGROUND OF THE INVENTION

1. Field of Invention

The invention relates to rotors, especially to brake rotors used in road vehicles. The invention particularly relates to the braking surface of a vehicular brake rotor.

2. Description of Related Art

Conventional brake assemblies include a brake rotor with a brake pad contact surface for contact with brake pads associated with a vehicle wheel to effect braking. The brake pad contact surface can be an annular ring that engages with the brake pad, which is typically a high friction material, to stop rotation of the brake rotor, which is connected to a hub of a wheel assembly.

Rotors used in road vehicles typically have a smooth brake pad contact surface. During operation, the brake pad will be pressed against the rotor surface to stop rotation of the wheel hub, which supports the rotor. Some prior art rotors have been designed to increase friction by modifying the surface of the rotor to provide some texture.

However, increased friction causes additional heat to be generated across the brake pad contact surface of the rotor during braking. Heat generation, particularly with increased friction, results in an uneven thermal gradient, thermal distortion of the brake pad contact surface and heat stress that deteriorates the rotor disk. Such heat effects can result in increased replacement and maintenance costs for brake rotor assemblies.

One way to increase friction is to provide through holes in the braking surface. Such holes, while increasing friction, create stress concentrations in the rotor surface, which leads to cracking. Cracked rotors require replacement, which can be costly, especially for road vehicles. Additionally, manufacturing rotors with through holes requires lengthy machining time and tool wear.

Another way to increase friction is to provide elongated grooves in the braking surface. This is shown in U.S. Pat. No. 6,446,770, which is related to this application and is also assigned to Performance Friction Corporation. U.S. Pat. No. 6,446,770 has a pattern of elongated shallow grooves arrayed across the braking surface that provides an excellent braking surface, which is particularly effective for more aggressive friction material in high performance applications.

With the increased friction, the braking surface also experiences increased heat. Some rotors are designed to accommodate increased heat by providing ventilation channels. This type of brake rotor, typically called a ventilated rotor, includes a pair of brake pad contact surfaces spaced from each other, generally by a plurality of spaced vanes or ribs. The vanes or ribs allow air to circulate under the brake pad contact surface for cooling.

However, ventilation alone does not remedy problems associated with non-uniform heat distribution across the brake pad contact surface that can create thermal distortion and frictional instability. Ventilated brake rotors have uneven temperature gradients over their brake pad contact surfaces. This is due to the heat sink capability of the vanes underneath the brake pad contact surfaces. Heat generated on the brake pad contact surfaces on the areas that overlap a vane is directly transferred to the corresponding vane. Heat generated during braking on the brake pad contact surfaces on the areas between vanes is not directly transferred to a vane. Accordingly, the temperature of the brake pad contact surfaces in the areas between vanes is higher than in the areas that overlap a vane. This non-uniform temperature gradient contributes to thermal distortion on the rotor brake pad contact surfaces. The thermal distortion results in non-uniform contact between brake pads and the brake pad contact surfaces which further increases the thermal gradient, causes premature rotor and pad wear, and increases thermal judder and vibration. Thermal distortion further results in thermal checking in the rotor and decreased rotor life.

Another problem with friction surface texture is increased noise generated during braking. While texture increases friction, it also creates a disturbance between the brake pad and rotor surface. This disturbance can create noise, which can become an issue in the final vehicle design.

For example, the rotors described in U.S. Pat. No. 6,446,770, discussed above, tend to generate high noise levels during braking. While high noise levels are acceptable in racing situations, it is preferably to have minimal noise levels during braking in typical automobile road use.

Thus, there is a need for a brake rotor that has an improved friction surface while accommodating increased heating and noise generation that can occur with increased friction. There is also a need for a brake rotor that is durable and economical.

### SUMMARY OF THE INVENTION

One aspect of embodiments of the invention is to provide a rotor with a brake pad contact surface that offers enhanced braking power and performance. The surface can increase friction and stopping power while maintaining frictional stability throughout the braking application.

Another aspect of embodiments of the invention is to provide a rotor with a brake pad contact surface that reduces the non-uniform temperature distribution (thermal gradient) across the brake pad contact surface during automobile braking. Accordingly, thermal distortion and the numerous problems associated with thermal distortion is minimized.

An additional aspect of the embodiments of the invention is to provide a rotor with a brake pad contact surface that performs with reduced vibration and thermal judder during braking, especially due to the decreased thermal distortion. Accordingly, a decrease in thermal distortion contributes to smooth braking.

Another aspect of embodiments of this invention is to reduce machining time and tool wear compared to conventional rotors with through holes.

A further aspect of the embodiments of the invention is to provide a rotor with a break pad contact surface in which the thermal gradient across the Surface is reduced, resulting in decreased thermal checking and an increase in rotor life.

Also, the embodiments of the invention provide a rotor in which uniform contact is promoted between the rotor and brake pads. Non-uniform contact typically results from thermal distortion. Uniform contact can result in a decrease of taper and radial wear on the pads and an increase in pad life. Uniform contact also can decrease uneven wear. Uniform contact also minimizes undesirable frictional variability between the pads and the brake pad contact surface.

A further aspect of embodiments of this invention is to provide an indentation at each position across the radius of the braking surface so as to thoroughly swipe the braking surface, if desired, and minimize friction material build up on the braking surface.

The embodiments of the invention further provide a noise characteristic so that during operation the friction enhanced surface of the rotor does not create more noise than a smooth disk would create when the brake pad is applied.

The rotor in accordance with the invention has a plurality of indentations formed in the surface thereof. The indentations can be formed in a pattern. The various design possibilities and optimal design for each particular braking application can be established using finite element analysis based on computer simulations. Goals of the ultimate design can include increasing friction between brake pads and the brake pad contact surface, decreasing the thermal gradient and thus decreasing thermal distortion on the rotor, and decreasing noise generation.

Other aspects, advantages and objects of the invention will become apparent with the description herein, especially when taken in conjunction with the detailed description and drawings.

### BRIEF DESCRIPTION OF THE DRAWINGS

FIG. 1 is a front view of a brake rotor in accordance with an embodiment of the invention;

FIG. 2 is an enlarged view of section A taken from the brake rotor of FIG. 1;

FIG. 3 is an enlarged cross sectional side view of the brake rotor of FIG. 1;

FIG. 3A is enlarged view of section B from FIG. 3 showing the indentations in detail;

FIG. 4 is a front view of a brake rotor in accordance with another embodiment of the invention;

FIG. 5 is an enlarged view of section C taken from the brake rotor of FIG. 3;

FIG. 6 is a front view of a brake rotor in accordance with another embodiment of the invention;

FIG. 7 is a front view of a brake rotor in accordance with another embodiment of the invention;

FIG. 8 is an enlarged partial view of a brake rotor in accordance with an additional embodiment of the invention;

FIG. 8A is an enlarged partial view of a brake rotor in accordance with a modification of the embodiment of FIG. 8;

FIG. 9 is an enlarged partial view of a brake rotor in accordance with an additional embodiment of the invention;

FIG. 10 is an enlarged partial view of a brake rotor in accordance with another embodiment of the invention;

FIG. 11 is a front view of a brake rotor with an integrated hub in accordance with another embodiment of the invention;

FIG. 12 is a side view in cross section of the rotor of FIG. 11 taken along line XII-XII;

FIG. 13 is a front view of a brake rotor in accordance with another embodiment of the invention;

FIG. 14 is a front view of a brake rotor connected to a hub assembly;

FIG. 14A is a side view in cross section of the assembly of FIG. 14 taken along line XIV-XIV;

FIG. 15 is a front view of a brake rotor in accordance with another embodiment of the invention; and

FIG. 15A is an enlarged view of section D of FIG. 15.

### DETAILED DESCRIPTION OF PREFERRED EMBODIMENTS

Preferably, the brake rotor described herein is designed for road use for automobiles. However, this application is merely exemplary, and it is not intended that the invention be limited to such applications or vehicles. It is also contemplated that the brake rotor described herein could also be used in high performance applications, such as for racing vehicles or heavy duty trucks.

The brake rotors described herein are intended to representative of various types of known rotor configurations. For example, the rotor can be a hatless rotor configuration, an integral hat rotor configuration, or an integral hat and hub rotor configuration.

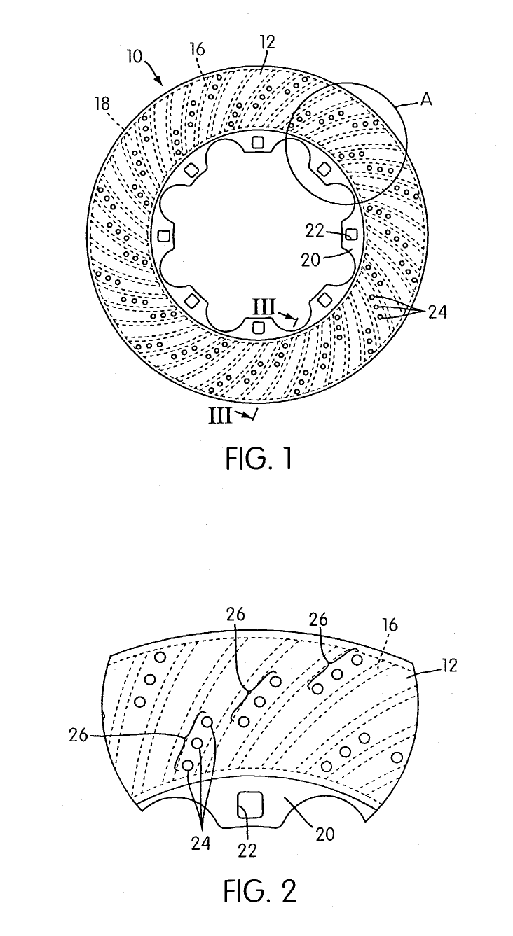

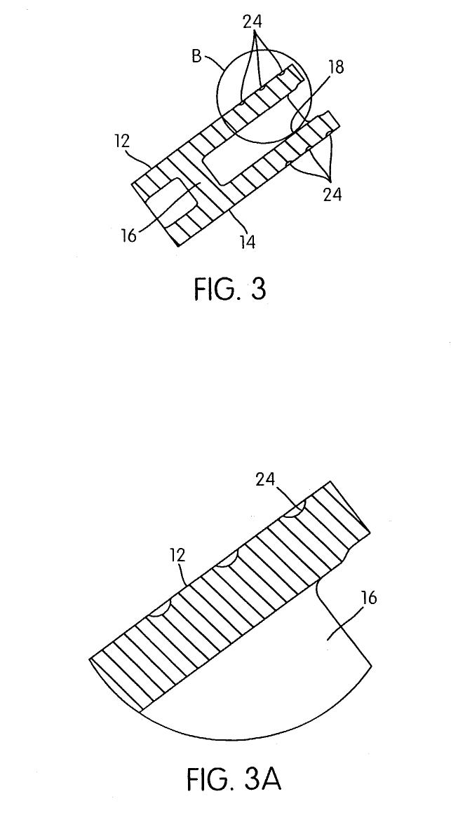

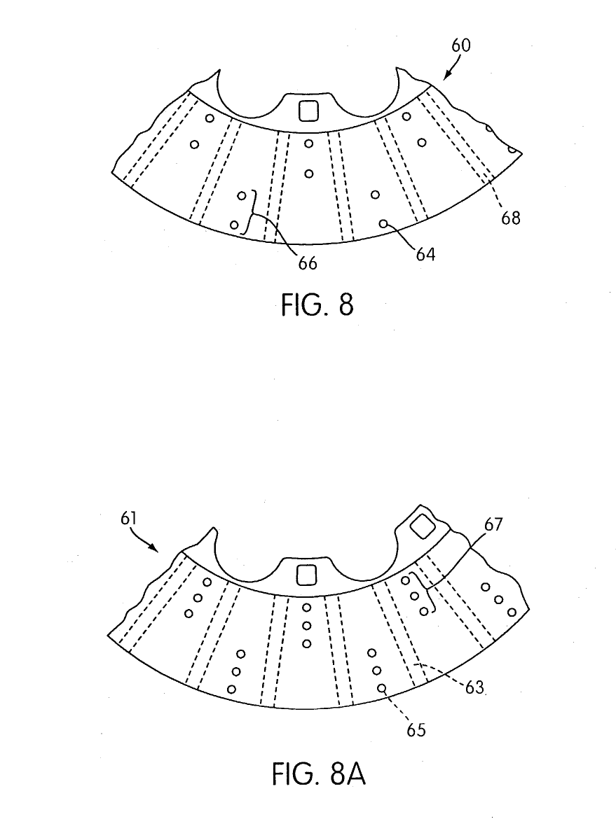

The brake rotor 10 of FIG. 1 is a ventilated rotor having a first braking surface 12 and a second braking surface 14 (seen in FIG. 3) opposed to the first surface 12. The first and second surfaces 12, 14 are preferably formed in an annular ring shape and may have a treated surface designed for braking. A series of vanes 16, shown in phantom in FIG. 1, extend between the first surface 12 and the second surface 14 to space the surfaces and provide ventilation passages 18. The vanes 16 are circumferentially spaced between the first and second braking surfaces 12, 14. Vanes 16 may be spaced in any desired configuration, and any number may be used depending on the particular design considerations. Preferably, the vanes 16 are spaced at regular intervals, as is shown in FIG. 1. The vanes 16 are shown curved in FIG. 1. However, ventilation vanes may also be straight, as seen in FIG. 8 for example, if desired.

The brake rotor 10 is designed for attachment to a wheel hub on a vehicle. An attachment flange 20 extends inwardly from each surface 12, 14 for attachment to the wheel hub. The attachment flange 20 may be a series of tabs, as seen in FIG. 1, or an annular flange. The attachment flange 20 has a series of spaced apertures 22 to receive fasteners for securing the wheel hub.

In use, the brake rotor 10 will rotate with the wheel and wheel hub. A brake pad or a pair of brake pads, preferably mounted on a brake caliper, are mounted to move toward the surface of the brake rotor 10 to engage the brake rotor 10 and stop rotation of the wheel hub.

The first surface 12 has a plurality of indentations or dimples 24 formed therein. The indentations 24 are spaced around the braking surface of the rotor 10. Preferably, the indentations 24 are formed as concave depressions in the braking surfaces 12, 14. The indentations 24, seen in FIG. 3A, are partially spherical, but may be made in any shape, including but not limited to an oval, arc, wedge, square or rectangular shape. The indentations 24 may also be made in any size, both larger and smaller than shown. Each indentation 24 on a single disk 10 may have the same shape and size or may vary in shape and/or size across the surface of tile disk 10.

The indentations 24 may be formed by cutting into the braking surface 12, 14. In a preferred embodiment, the brake rotor 10 is formed of cast iron with or without an alloy, and the indentations 24 are cut into the surface 12, 14 with a chamfer tool, for example. The depth of tie indentation 24 is determined by the wear of the particular rotor 10, but is preferably shallow. For example, in one embodiment, the depth of the indentation 24 may be approximately 1.0-1.5 mm. In any event, the indentations 24 do not extend all the way through the braking surface 12, 14. It is also possible to form the indentations 24 by other techniques, including embossing.

The indentations 24 may be arranged in groups extending radially outward from the inner circumference to the outer circumference of the braking surface 12, as seen in FIGS. 1 and 2. Each group 26 includes a series of indentations 24 in alignment. The groups 26 are circumferentially and radially offset from an adjacent group. In the embodiment seen in FIGS. 1-3, each group 26 includes three indentations 24, and three repeating groups 26 extend from the inner circumference to the outer circumference. Of course, any number of indentations and groups may be used. Preferably, the indentations 24 do not extend into the inner circumference or the outer circumference.

As seen in detail in FIG. 2, each group 26 of indentations 24 is located on the surface 12 positioned between the vanes 16. This positioning promotes uniform temperature distribution across the surface 12. It is also possible to position the indentations 24 over the vanes 16 or at positions unrelated to the location of the vanes 16. The second surface 14 can also have similar groups 26 of indentations 24 formed therein. The indentations 24 on the second surface 14 may be aligned with the indentations 24 on the first surface 12 or may be offset with respect to the first surface 12.

Using a series of indentations 24 in a predetermined pattern reduces the discontinuity between the braking surface 12, 14 and the brake pad. Friction is increased due to the indentations 24. However, noise generated by the brake pad contacting the discontinuous surface of the braking surfaces 12, 14 is minimized because less disturbance is created by the short bursts of discontinuity. For example, slots formed in the surface of a rotor can create a large disturbance thus generating excessive groaning or noise upon the application of the brake pads. With the dimpled design of this invention, the noise is not significantly increased compared to a smooth disk.

Also, the indentations 24 provide more uniform temperature distribution across the brake pad contact surfaces 12, 14, which leads to less thermal stress, less thermal distortion, and a longer disk life. Thus, the brake rotor 10 in accordance with this invention provides increased braking power due to the friction created by the indentations 24, while achieving an even temperature distribution providing a more durable disk and low noise during braking.

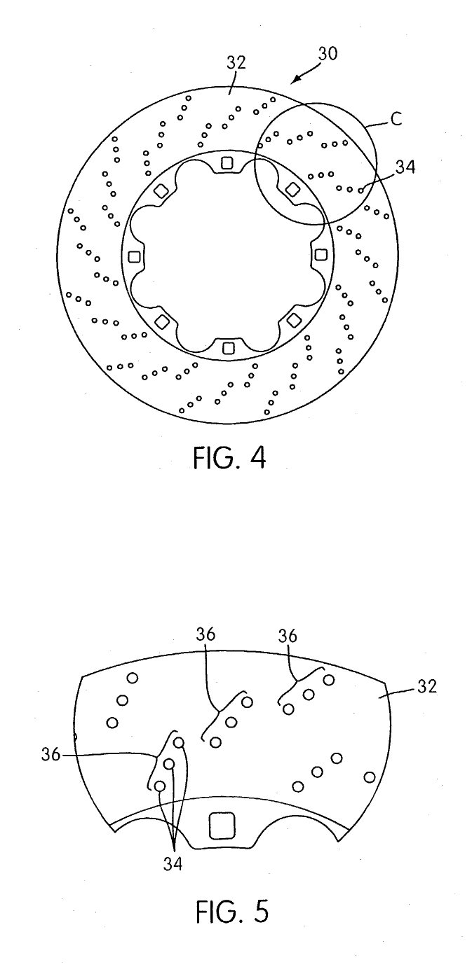

FIGS. 4 and 5 show another embodiment of a brake rotor 30 in accordance with the invention. The brake rotor 30 is a single disk with a braking surface 32. Preferably, a braking surface is also disposed on the opposite side (not shown in FIG. 4). A series of indentations 34 are formed in the surface 32 in a similar manner as described with respect to the embodiment of FIG. 1. As seen in detail in FIG. 5, the indentations 34 are arranged in groups 36 radially spaced between the inner circumference and the outer circumference. Three groups 36 each having three indentations 34 are shown, but any number of groups and indentations may be used. Similar to the embodiment above, the braking surface on the opposed side of the rotor 30 can have groups of indentations as well.

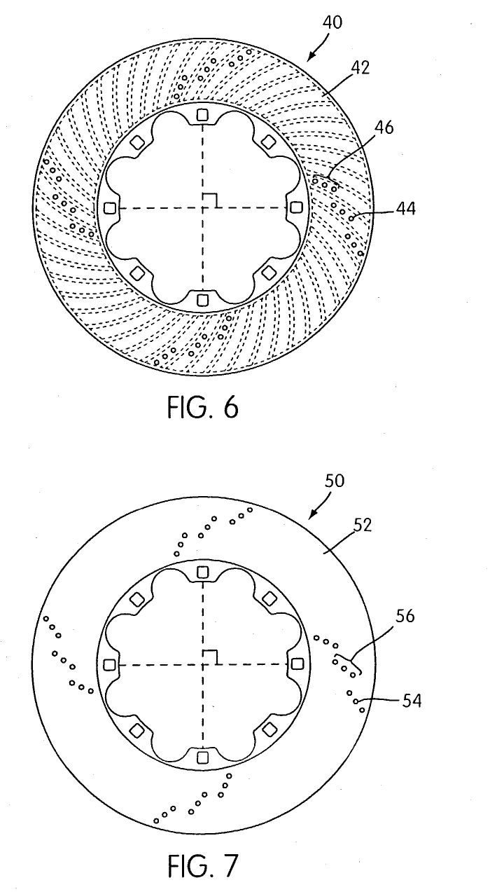

FIG. 6 shows a ventilated brake rotor 40 having a braking, surface 42 with a different arrangement of indentations 44 in three groups 46 separated by approximately 90 degrees. This arrangement provides an enhanced friction surface while reducing the stress concentrations, accommodating heating and providing an acceptable noise characteristic. The groups 46 may be arranged at any position relative to another, for example with more groups separated by less than 90 degrees or less groups separated by more than 90 degrees.

FIG. 7 shows a brake rotor 50 having a similar arrangement of indentations as seen in FIG. 6, but formed on a single, non-ventilated disk. Rotor 50 has a braking surface 52 with a series of indentations 54 arranged in four sets of groups 56 disposed at approximately 90 degrees from each other. Again, the opposed surface is preferably a braking surface with indentations as well.

FIG. 8 illustrates a modification of a rotor 60 having a pattern with a series of two radially spaced groups 66 of two indentations 64 disposed between straight ventilation vanes 68.

FIG. 8A illustrates a rotor 61 similar to the rotor of FIG. 8 having straight ventilation vanes 63 with three indentations 65 in each group 67 of indentations.

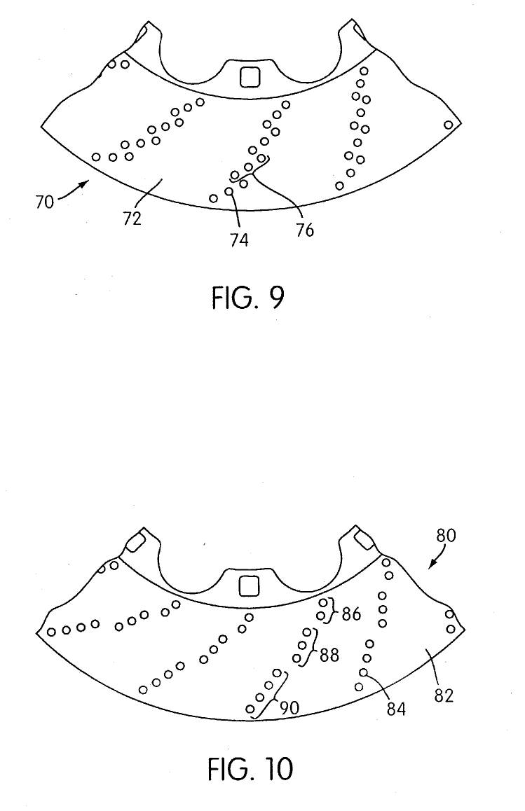

FIG. 9 illustrates a rotor 70 having a braking surface 72 with indentations 74 arranged in four groups 76 radially offset from each other. Each group in this case includes three indentations 74.

FIG. 10 illustrates a rotor 80 having a braking surface 82 with indentations 84 arranged in groups 86, 88, and 90, each group having a different number of indentations 84. Tile groups may be positioned at any location across the rotor surface 82. In this example, group 86 includes two aligned indentations 84, group 88 includes three aligned indentations 84, and group 90 includes four aligned indentations 84.

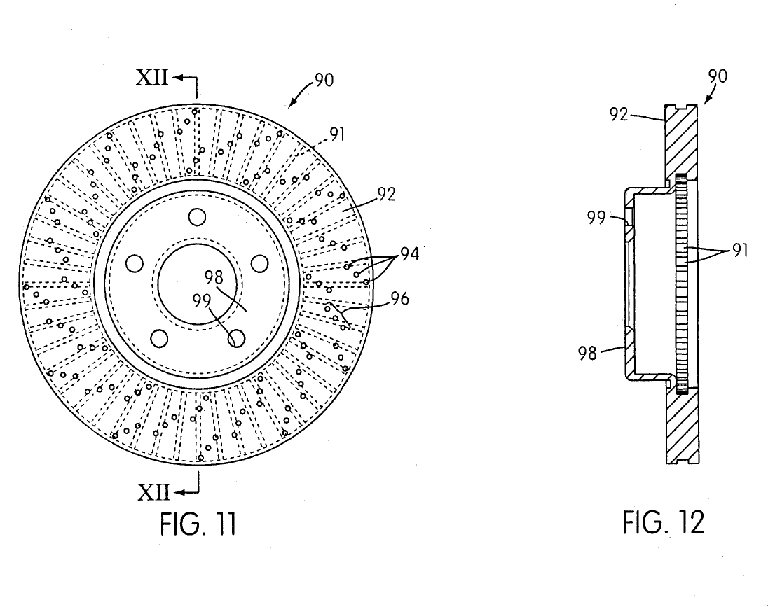

FIG. 11 illustrates an integral hat and hub type rotor 90 with straight ventilation vanes 91. The rotor 90 has a braking surface 92 with indentations 94 arranged in groups 96. The connection flange 98 is configured as a raised hat shape with hub fastener apertures 99, as seen in FIG. 12. In this embodiment, the indentations 94 are arranged in groups 96 of three indentations, with three groups spanning the width of the braking surface 92. However, as with each embodiment, any number of indentations or groups may be used.

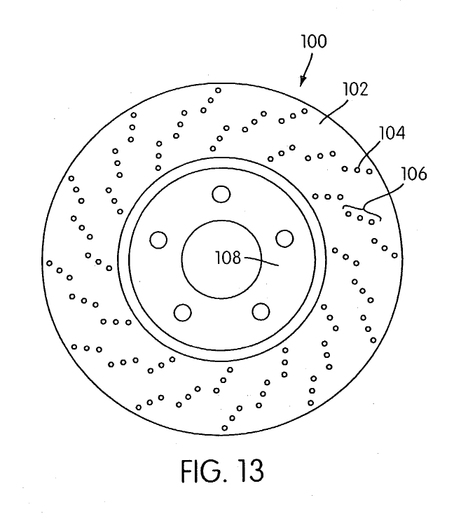

FIG. 13 illustrates an integral hat and hub type rotor 100 with no ventilation vanes, in other words, a flat or single disk type rotor, having a braking surface 102 with a plurality of indentations 104 arranged in groups 106. An integral hat and hub attachment portion 98 is provided, similar to the portion shown in FIG. 12.

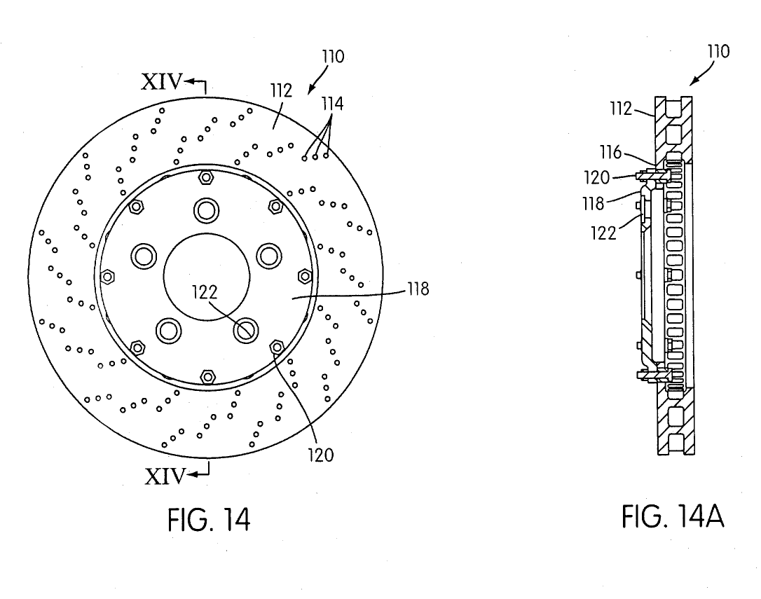

FIG. 14 shows a rotor 110 having a braking surface 112 with indentations 114. The rotor 110 has an attachment portion 116 that is fastened to a hat 118 with fasteners 120. The hat 118 has openings 122 for attachment to a hub. As seen in FIG. 14A, the rotor 110 may be ventilated.

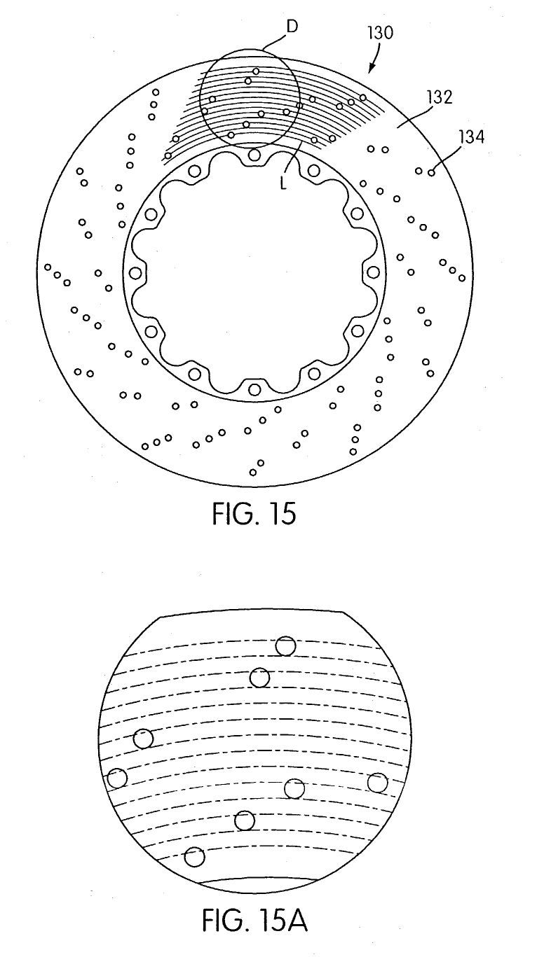

FIG. 15 shows a rotor 130 having a braking surface 132 with indentations 134 arrayed in a pattern that provides an indentation at each radial position between the inner circumference of the disk and the outer circumference of the disk. These positions are represented in FIG. 15 by lines L, which are imaginary lines to illustrate that the entire radial surface is occupied by an indentation 134. The indentations 134 can be positioned at immediately adjacent radial positions or at overlapping radial positions. As seen, the pattern includes a series of groups of three indentions 136 that alternate with a series of groups of two indentations 138. However, the precise grouping and arrangement call vary in this embodiment as long as each radial position is occupied by an indentation 134. Also, the rotor 130 can be a single disk or a ventilated disk and can attach any known way to the wheel hub.

This positioning allows the indentations 134 to provide a cleaning effect to the braking surface. As the brake pads press against the braking surface 132 while the rotor 130 is rotating, the friction material is scraped from the brake pads. This friction material can accumulate on the braking surface 132 and create a transfer layer of friction material on a smooth braking surface, especially when aggressive friction material is used as in high performance applications. The indentations 134, however, prevent the transfer layer from accumulating. However, when the indentations 134 are radially spaced, the transfer layer can build up in ridges in the areas between the indentations 134 and cause a rippled effect on the braking surface 132, which impairs rotor performance. A pattern that positions an indentation 134 across the entire width of the braking surface 132 prevents such rippling.

Thus, it can be seen by the various embodiments described above that any type of rotor may be used with the this invention, which provides indentations, preferably arranged in a pattern, on a braking surface to enhance braking while minimizing negative effects of increased friction. While most embodiments shown in the attached figures illustrate only one surface for the sake of simplicity, it should be understood that most braking applications would include two surfaces on opposed sides of the rotor.

The various embodiments described above are intended to illustrate that any number of indentations in any arrangement of patterns or groups may be used in this invention. The precise number and arrangement are dependent on the particulars design considerations of the vehicle intended to be used with the rotor in accordance with this invention. It is also contemplated that the indentations can be arranged in an evenly spaced pattern across the braking surface, for example, with no particular grouping. The indentations could also be arranged randomly across the surface and still remain within the scope of this invention.

While advantageous embodiments have been chosen to illustrate the invention, those skilled in the art will understand that various changes and modifications can be made therein without departing from the scope of the invention.

What is claimed is:

1. A rotor comprising:
a disk having a thickness and at least one brake pad contact surface bounded by an inner, circumference and an outer circumference, the brake pad contact surface including a plurality of indentations formed therein in an area between the inner circumference and the outer circumference, wherein the indentations have a depth less than the thickness of the disk; and
an attachment portion extending from the disk for attachment to a wheel.

2. The rotor of claim 1, wherein the indentations are circular.

3. Tile rotor of claim 1, wherein the indentations form a concave dimple.

4. The rotor of claim 1, wherein each indentations is discrete.

5. The rotor of claim 1, wherein the indentations are arranged in a pattern formed of groups of aligned indentations extending generally from within the inner circumference toward the outer circumference.

6. The rotor of claim 5, wherein the pattern includes a series of groups of indentations with each group of indentations being radially and circumferentially offset from an adjacent group.

7. The rotor of claim 5, wherein the pattern includes a first set of groups of indentations extending from within the inner circumference toward the outer circumference and a second set of groups of indentations extending from within the inner circumference toward the outer circumference, wherein the first set of groups is circumferentially spaced from the second group by about 90 degrees and wherein the space on the brake pad surface between the sets of groups is not indented.

8. The rotor of claim 5, wherein the pattern includes a determined number n of sets of groups distributed evenly on the brake pad contact surface of the disk, such that each set is separated by an adjacent set by 360 degrees divided by n.

9. The rotor of claim 5, wherein each group includes at least two indentations.

10. The rotor of claim 5, wherein each group includes at least three indentations.

11. The rotor of claim 5, wherein there are at least three groups of indentations.

12. The rotor of claim 1, wherein the disk is annular and the attachment portion extends inwardly from the disk and includes a plurality of fastener holes.

13. The rotor of claim 1, wherein the rotor is a single disk.

14. The rotor of claim 13, wherein the rotor includes a brake pad contact surface on each opposed side of the single disk with each brake pad contact surface including indentations therein.

15. The rotor of claim 1, further comprising a wheel hub fastened to the attachment portion.

16. The rotor of claim 1, further comprising a hat fastened to the attachment portion.

17. The rotor of claim 1, further comprising a second disk having a thickness and a brake pad contact surface and a plurality of spaced vanes disposed between the disks creating a ventilated rotor.

18. The rotor of claim 17, wherein the second disk has a plurality of indentations formed in the brake pad contact surface.

19. The rotor of claim 18, wherein the indentations of the second disk are aligned with the indentations of the first disk.

20. The rotor of claim 18, wherein the indentations of the second disk are offset with respect to the indentations of the first disk.

21. The rotor of claim 17, wherein the vanes are curved and the indentations are arranged in arcuate lines.

22. The rotor of claim 17, wherein the vanes are straight.

23. The rotor of claim 17, wherein the indentations are disposed on the brake pad contact surface in position between the vanes.

24. The rotor of claim 1, wherein the indentations are arranged in an arc.

25. The rotor of claim 1, wherein the indentations are arranged in a straight line.

26. The rotor of claim 1, wherein the attachment portion includes a series of spaced tabs, each tab having a fastening aperture therein.

27. The rotor of claim 1, wherein the attachment portion includes an annular ring with a raised central portion.

28. The rotor of claim 1, wherein the rotor is a hat type rotor.

29. The rotor of claim 1, wherein the rotor is a hub type rotor.

30. The rotor of claim 1, wherein the indentations are positioned such that there is at least one indentation located at each radial position between the inner circumference and the outer circumference.

31. A rotor for attachment to a wheel of a road vehicle, comprising:
a disk having opposed sides, each side having a braking surface, wherein at least one braking surface has a plurality of indentations formed in the surface thereof, and wherein the indentations are shallow, discrete dimples.

32. The rotor of claim 31, wherein the dimples are arranged in a pattern across the braking surface, the pattern including groups of dimples, wherein each group of dimples is offset radially and circumferentially from an adjacent group.

33. The rotor of claim 31, wherein the disk is a single plate.

34. The rotor of claim 31, wherein the disk is formed of a pair of spaced plates separated by ventilation vanes.

35. The rotor of claim 31, wherein the braking surface has a width, and the dimples are positioned across the entire width of the braking surface.

36. The rotor of claim 35, wherein dimples located at different radial positions on the braking surface radially overlap with at least one other dimple.

37. The rotor of claim 36, wherein adjacent dimples are circumferentially offset.

38. A brake rotor for use on a wheel of a vehicle, comprising:
a disk having a braking surface on each side, wherein each braking surface has a width and a plurality of shallow, discrete dimples formed across the width thereof, the dimples being circumferentially offset from adjacent dimples and covering the entire radial width of the braking surface; and
an attachment portion extending from the disk for attachment to a wheel hub.
